(19) United States
(12) Patent Application Publication
(10) Pub. No.: US 2002/0118631 A1
(43) Pub. Date: Aug. 29, 2002

(54) Ball balancer for wide rotation speed

(76) Inventors: Lih-Hwa Kuo, Taipei (TW); Yi-Cheng Tsao, Hsinchu (TW)

Correspondence Address: Rosenberg, Klein & Lee, 3458 Ellicott Center Drive-Suite 101, Ellicott City, MD, 21043, US

(21) Appl. No.: 09/754,344

(22) Filed: Jan. 5, 2001

(51) Int. Cl. G11B 17/028

(52) U.S. Cl. 369/264; 369/263; 360/99.08

(57) ABSTRACT

A ball balancer comprises a main body mounted on spindle motor of rotary machine, and centered at the spindle. The main body contains at least one magnetic ball, which can be of spherical shape, cylindrical shape or other rollable shape. The main body further contains a magnet arranged at inner center part thereof. Preferably, a magnetic circular disk made of magnetic material is arranged on the magnet. The circumference of the circular disk is concentric with the shaft of the spindle motor. The main body further contains a roll-retarding unit, which is a deformable elastic body around the magnetic ball.

### FIELD OF THE INVENTION

The present invention relates to a ball balancer for wide-range operation of rotation speed, especially to a ball balancer mounted on a spindle motor of optical disk driver to reduce vibration and noise generated from the optical disk driver and being applicable for wide rotation speed. By this invention, the application of the inventive ball balancer can be broader than that of conventional ball balancers.

### BACKGROUND OF THE INVENTION

The conventional ball balancer for optical disk driver generally comprises at least one race that is mounted on the spindle motor, and a plurality of balls free running within the race. When the rotation speed of the rotor exceeds a critical rotation speed, the plurality of balls are automatically rolled to positions that balance the imbalanced rotor, according to the magnitude and orientation of the imbalanced rotor. Therefore, the vibration and noise coming from the imbalanced rotor are reduced. However, the balls of the conventional ball balancer will be rolled to the positions that increase the imbalance of the rotor when the rotation speed of the rotor is less than the critical rotation speed. In other word, the conventional ball balancer cannot be applied to application of low rotation speed or wide speed range.

### SUMMARY OF THE INVENTION

It is the object of the present invention to provide a ball balancer for wide-range operation of rotation speed, wherein the balls will not roll to imbalance position and increase vibration as the rotation speed of the rotor is smaller than or equal to the critical rotation speed.

To achieve the above object, the ball balancer according to the present invention comprises a main body, at least one magnetic ball, a magnet and a roll-retarding unit. The magnetic ball and the magnet are located within the main body and the magnet is used to attract the magnetic ball. The roll-retarding unit is arranged around the magnetic ball to stop the further rolling of the ball after escaping from the magnet.

The various objects and advantages of the present invention will be more readily understood from the following detailed description when read in conjunction with the appended drawing, in which:

### BRIEF DESCRIPTION OF DRAWING

FIG. 1 is the sectional view of the first preferred embodiment of the present invention;

FIG. 2 is the top view of the first preferred embodiment of the present invention;

FIG. 3 shows the magnetic flux contour in the first preferred embodiment of the present invention;

FIG. 4 shows the movement of magnetic balls in the first preferred embodiment of the present invention;

FIG. 5 shows the exponential change of magnetic force in the first preferred embodiment of the present invention;

FIG. 6 shows the movement of the magnetic ball during operation in the first preferred embodiment of the present invention;

FIG. 7 shows the exponential change of magnetic force in the first preferred embodiment of the present invention;

FIG. 8 is the top view of the second preferred embodiment of the present invention.

### DETAILED DESCRIPTION OF THE INVENTION

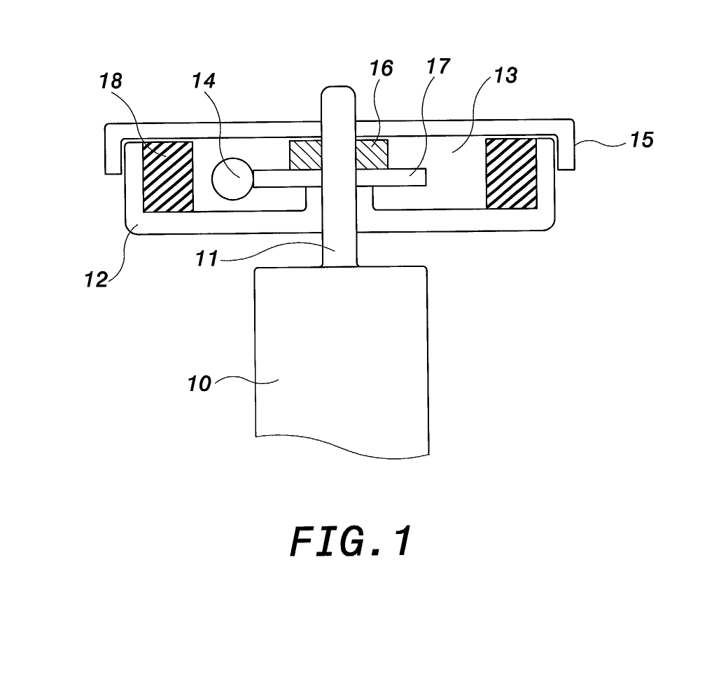

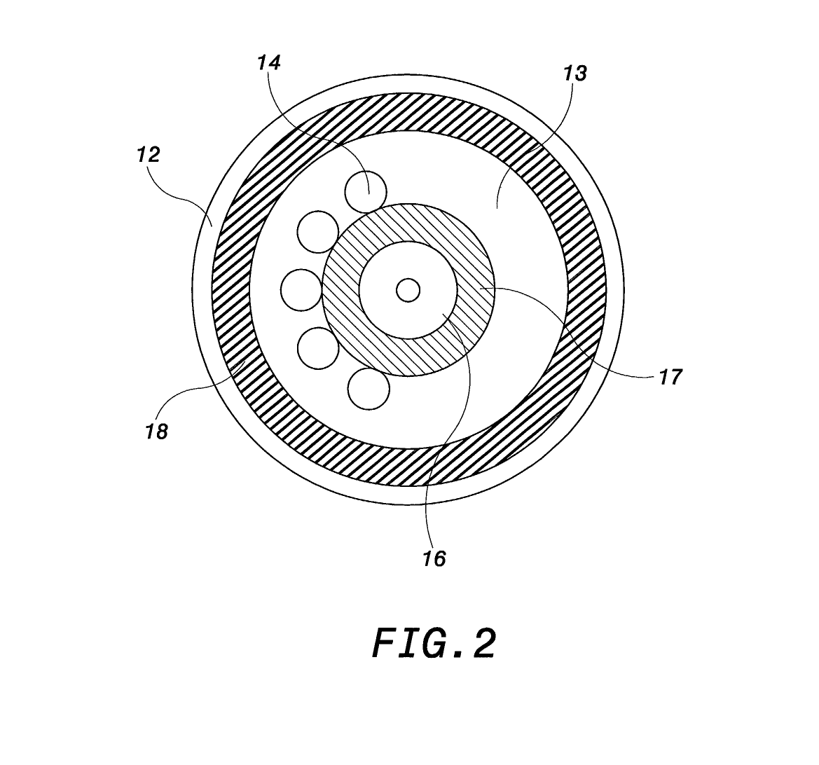

With reference now to FIGS. 1 and 2, the present invention is intended to provide a ball balancer applicable for wide rotation speed. The ball balancer according to the first preferred embodiment of the present invention comprises a main body 12 mounted on a shaft 11 of a rotor 10 of an optical disk driver, and centered at the shaft 11. The main body 12 has a circular accommodating space 13, which is of annual groove shape and contains at least one magnetic ball 14 made of magnetic materials. The magnetic ball 14 can be of spherical shape, cylindrical shape or other rollable shape. Moreover, the opened side of the accommodating space 13 is covered by a cover 15.

The accommodating space 13 contains a magnet 16 arranged at inner center part of the accommodating space 13. The magnetic ball 14 is arranged outside the magnet 16. Preferably, a magnetic circular disk 17 made of magnetic material is arranged on the magnet 16. The circumference of the circular disk 17 is concentric with the shaft 11. The accommodating space 13 further contains a roll-retarding unit 18, which is a deformable elastic body in this embodiment. The roll-retarding unit 18 is made of elastic material such as rubber and is of annulus shape with outer radius similar to the inner radius of the accommodating space 13. The roll-retarding unit 18 is retained on inner surface of the accommodating space 13 by binding or locking and around the magnetic ball 14.

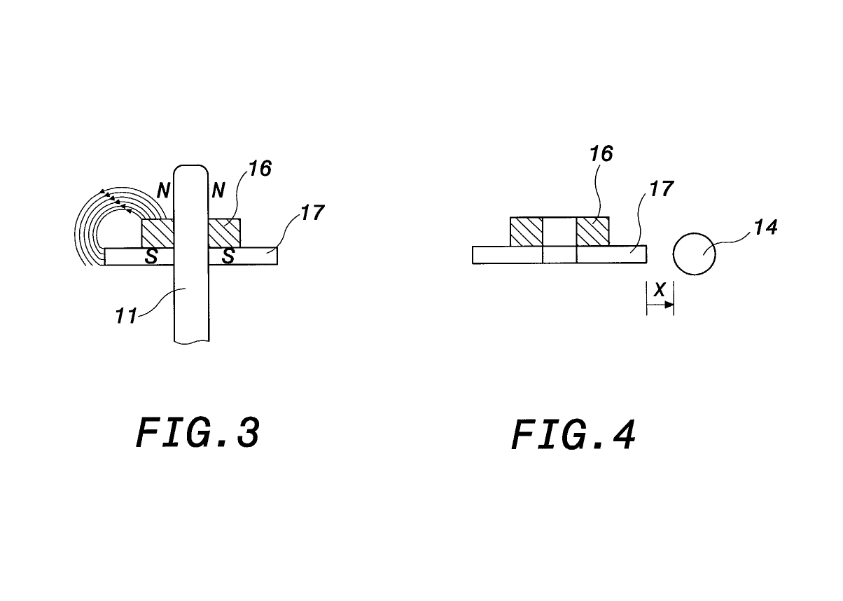

When the rotor 10 is at rest, the magnet 16 and the magnetic circular disk 17 provide magnetic flux as shown in FIG. 3. In this situation, the magnetic ball 14 is attracted to outer circumference of the magnetic circular disk 17 or the magnet 16.

When the rotor 10 is started to rotate, the magnetic ball 14 is subjected to following forces:

(1) The force that is tangent to the outer circumference of the magnetic circular disk 17

When the rotation speed of the rotor 10 is less than the critical speed, the magnetic ball 14 is driven by the tangent force to positions enhancing the imbalance, thus increasing vibration. When the rotation speed of the rotor 10 is larger than the critical speed, the magnetic ball 14 is driven by the tangent force to positions opposite to the imbalance, thus reducing the vibration.

(2) The force that is radial to the magnetic circular disk 17

(i) The magnetic force F_{magnet} that is contributed by the magnet 16 and toward the center of the magnet 16 is

F_{magnet}=F₁e^{-(x/a)}

where F₁ is the magnetic force exerted on the magnetic ball 14 when the magnetic ball 14 is laid on the outer circumference of the magnetic circular disk 17.

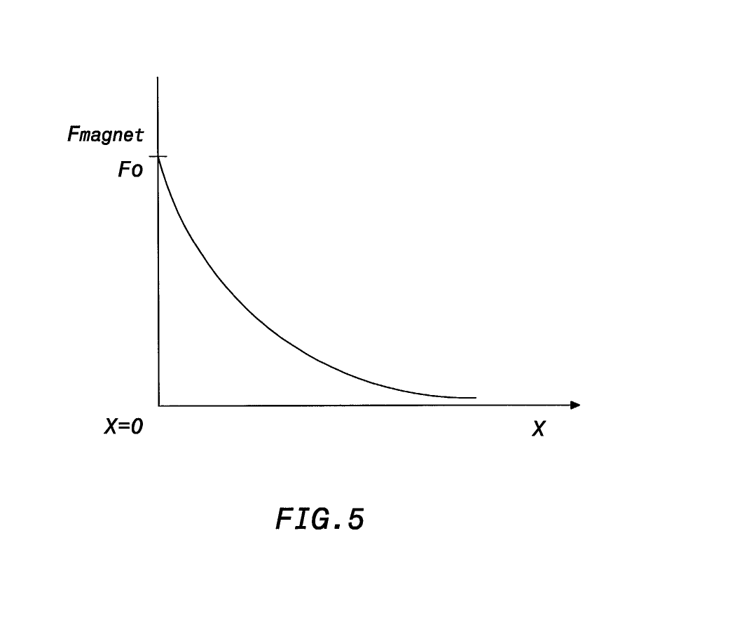

When the magnetic ball 14 escapes from the magnetic circular disk 17 and have separation x with the magnetic circular disk 17, the force F_{magnet} has exponential decay as shown in FIGS. 4 and 5.

(ii) The centrifugal force F_{centrifugal} that is due to rotation of the rotor 10 and away from the center of the rotor 10 is

F_{centrifugal}=mrω²

where

r is the radius to the center of the balls

ω is the rotation speed

m is the mass of each ball

When the magnetic ball 14 is laid on the outer circumference of the magnetic circular disk 17, i.e., x=0, provided that the radius of rotation for the center of the balls is r₀, then

F_{centrifugal}|ᵣ₌ᵣ_{₀}=mr₀ω²

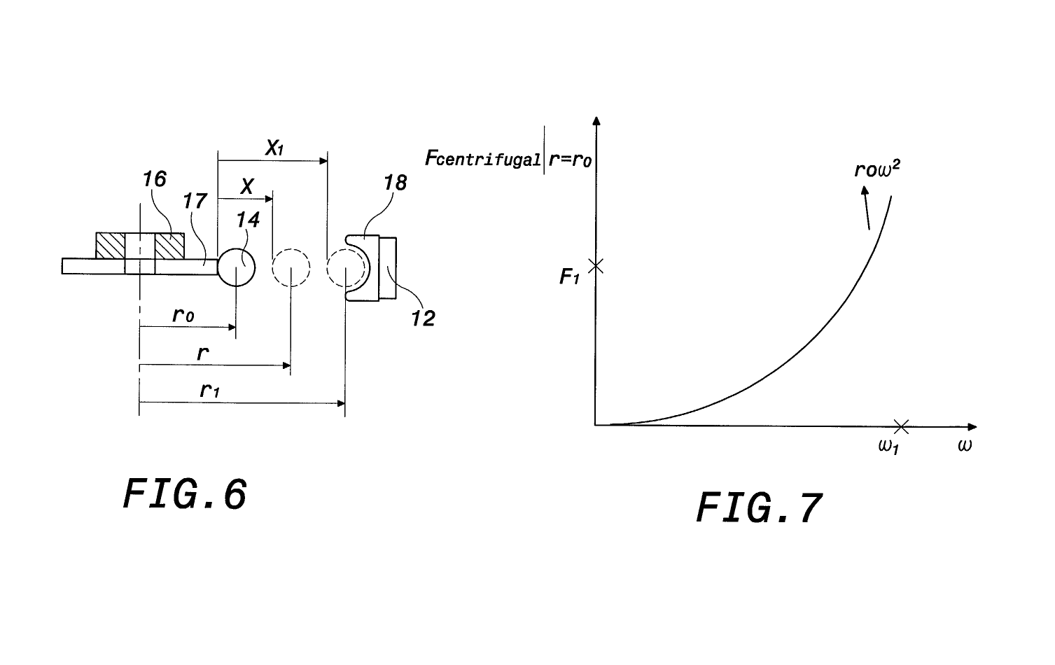

When the centrifugal force is slightly larger than the magnetic force, as shown in FIGS. 6 and 7, the magnetic ball 14 will escape from the magnetic circular disk 17 with speed

$${ω}_{1} = \sqrt{\frac{{F}_{1}}{{mr}_{0}}}$$

where F₁ is the magnetic force exerted on the magnetic ball 14 when the magnetic ball 14 is laid on the outer circumference of the magnetic circular disk 17.

The parameters F₁, m, r₀ are such designed that ω₁ is larger than the critical rotation speed ω_{critical}. The magnetic ball 14 will initially roll to balance position and then escape from the magnetic circular disk 17 as the rotation speed is gradually increased.

The roll-retarding unit 18 has deformable property such that the roll-retarding unit 18 will be locally deformed by the centrifugal force of the magnetic ball 14 as the magnetic ball 14 escapes from the magnetic circular disk 17. The local deformation of the roll-retarding unit 18 prevents the magnetic ball 14 from further rolling and keeps the magnetic ball 14 staying at original balance position.

As shown in FIG. 7, as the magnetic ball 14 escapes from the magnetic circular disk 17, the magnetic ball 14 will deform the roll-retarding unit 18 and the center thereof has position r=r₁. Assume x=x₁ when r=r₁. Once the magnetic ball 14 escapes from the magnetic circular disk 17, enen though rotation speed is lowered down to below ω_{critical}, the magnetic ball 14 remains at balance position as long as

F_{magnet}|ₓ₌ₓ_{₁}+F_{elastic}<F_{centrifugal|}ᵣ₌ᵣ_{₁}=mr₁ω²

where F_{elastic} is the restoring force due to the elasticity of the roll-retarding unit 18.

Therefore, the inventive ball balancer is applicable to the rotation speed range below ω_{critical}.

When the rotor 10 stops rotating, the centrifugal force becomes zero and the magnetic ball 14 will be pushed toward the magnetic circular disk 17 due to the elastic force F_{elastic} caused by deformation of the roll-retarding unit 18 and the magnetic force F_{magnet} of the magnetic circular disk 17. Therefore, the magnetic ball 14 can be restored to initial state as the rotor 10 stops rotating.

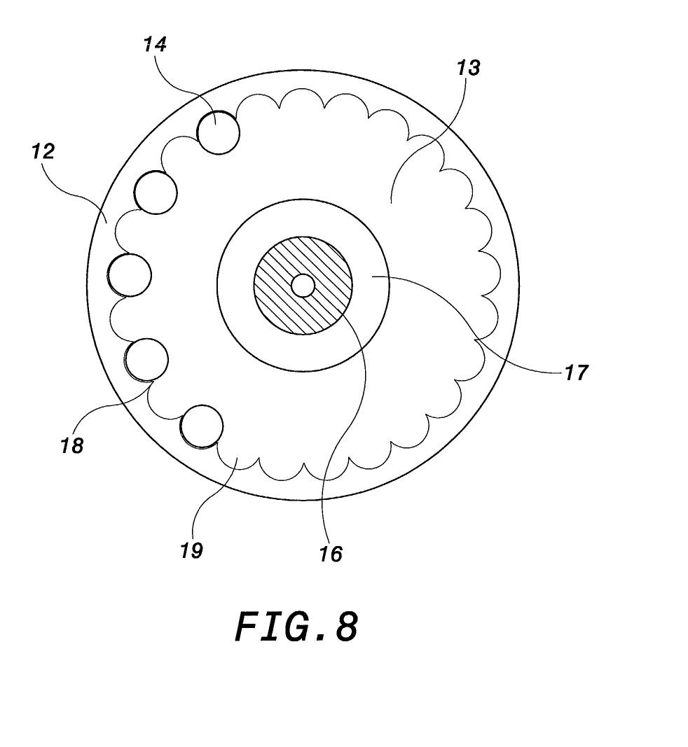

FIG. 8 shows the top view of the second embodiment of the present invention. In this embodiment, the roll-retarding unit 18 is integrally formed on the main body 12. More particularly, the roll-retarding unit 18 is composed a corrugated surface 19 on inner surface of the accommodating space 13. Therefore, the magnetic ball 14 will be retained on the concavity of the corrugated surface 19 and kept at balance position after they escape from the magnetic circular disk 17. When the rotor 10 stop rotating, the magnetic ball 14 will be attracted by the magnetic force of the magnet 16 and the magnetic circular disk 17, and then attached on the outer circumference of the magnetic circular disk 17.

To sum up, the present invention provides a novel structure to broaden the applicable rotation speed range and successively reduce the noise and vibration coming from imbalanced rotor.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A ball balancer for wide rotation speed operation, comprising a main body arranged on a rotor;
a magnet arranged within the main body;
at least one magnetic ball arranged within the main body and outside the magnet; the magnetic ball being able to attract to an outer circumference of the magnet;
a roll-retarding unit arranged around the magnetic ball and used to retain the magnetic ball after the magnetic ball escapes from the magnet.

2. The ball balancer for wide rotation speed operation as in claim 1, further comprising a magnetic circular disk around the magnet; the outer circumference of the magnetic circular disk being concentric with the center of the rotor.

3. The ball balancer for wide rotation speed operation as in claim 1, wherein the roll-retarding unit is a deformable elastic body.

4. The ball balancer for wide rotation speed operation as in claim 1, wherein the roll-retarding unit is composed a corrugated surface on the inner surface of the main body.
